(19) United States
(12) Patent Application Publication
(10) Pub. No.: US 2009/0106148 A1
(43) Pub. Date: Apr. 23, 2009

(54) PRE-PAID FINANCIAL SYSTEM

(76) Inventor: Christian Prada, Sunnyvale, CA (US)

Correspondence Address: Vierra Magen Marcus & DeNiro LLP, 575 Market Street, Suite 2500, San Francisco, CA, 94105, US

(21) Appl. No.: 12/253,646

(22) Filed: Oct. 17, 2008

Related U.S. Application Data
(60) Provisional application No. 60/980,535, filed on Oct. 17, 2007.

(51) Int. Cl. G06Q 40/00

(52) U.S. Cl. 705/41; 705/39; 705/44

(57) ABSTRACT

A pre-paid financial system using a common interface system is provided. Transactions are initiated on a number of different interfaces via a secure network or an unsecured network to a back-end system. The system maintains accounts funded via a pre-paid funding system. Transfers are made between users of the system after funding of the accounts is completed. The technology includes receiving a plurality of transaction requests from at least a first transaction interface and a second transaction interface via the insecure network. Each transaction interface receives user input including transaction instructions and outputs the instructions in a transaction request via the insecure network in a common syntax. The transaction command, transaction parameters, user token and authentication token are parsed and each transaction request authenticated. The request is evaluated against a set of permissible transaction rules and if the transaction request is permitted, the transaction is executed.

### CROSS REFERENCE TO RELATED APPLICATION

This application claims the benefit of provisional patent application Ser. No. 60/980,535, filed Oct. 17, 2007 by the present inventor, which is incorporated by reference.

### BACKGROUND

Financial services are provided by a broad range of institutions including banks, credit card companies, insurance companies, consumer finance companies, investment institutions and some government sponsored enterprises.

Almost all types of financial services are dependent upon customers having relationships with a financial institution. However, a substantial percentage of consumers do not use such conventional financial institutions. Unbanked consumers are often inconvenienced in making financial transactions and in many cases without bank accounts, a plurality of financial services are not available to them.

The services of banks and their infrastructure are not designed to handle small accounts. The return of cash assets held by any one individual doesn't offset the costs of managing a small account. Small bank accounts are an uneconomical proposition for banks and its customers. Banks loose money even charging high service fees while customers loose an important part of their assets with these charges.

### SUMMARY

A pre-paid financial system that provides cheaper and better financial services using a common interface system. Transactions may be initiated on a number of different interfaces via a secure network or an unsecure network to a back-end system. The system maintains accounts funded via a pre-paid funding system. Transfers are made between users of the system after funding of the accounts is completed.

In one aspect, the technology is a computer implemented method for completing a financial transaction between a first account holder and a second account holder via an insecure communication network. The technology includes receiving a plurality of transaction requests from at least a first transaction interface and a second transaction interface via the insecure network. Each transaction interface receives user input including transaction instructions and outputs the instructions in a transaction request via the insecure network in a common syntax. The transaction command, transaction parameters, user token and authentication token are parsed and each transaction request authenticated. The Request is evaluated against a set of permissible transaction rules and if the transaction request is permitted, the transaction is executed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG.1 is a general overview in accordance with an embodiment of the pre-paid financial system.

FIG. 2 illustrates a framework of a service-oriented architecture in accordance with an embodiment of the pre-paid financial system.

FIG. 3 illustrates a processing device suitable for use in the present technology.

FIG. 4A and FIG. 4B are a flowcharts showing an exemplary transaction processing method in accordance with an embodiment of the pre-paid financial system.

FIG. 5A to FIG. 5D are schematic diagrams showing examples of SMS Text messages flows in accordance with an embodiment of the pre-paid financial system.

FIG. 6A to FIG. 6G illustrate exemplary forms of browser generated transactions in accordance with an embodiment of the pre-paid financial system.

FIG. 7A to FIG. 7G illustrate exemplary forms of software program generated transactions in accordance with an embodiment of the pre-paid financial system.

FIG. 8 illustrates an apparatus in accordance with an embodiment of the pre-paid financial system.

### DETAILED DESCRIPTION

Technology is presented for enabling a pre-paid financial system that provides cheaper and better financial services using a common interface system. Transactions may be initiated on a number of different interfaces via a secure network or an insecure network to a back-end system. The system maintains accounts funded via a pre-paid funding system.

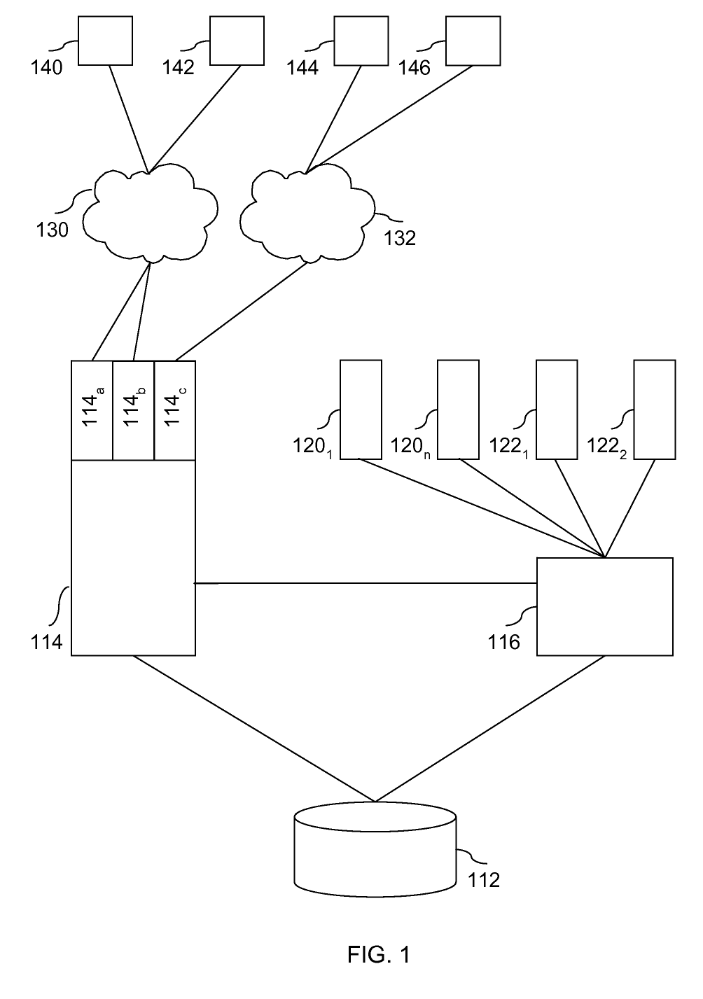

An embodiment of the pre-paid financial system is illustrated in FIG. 1. Alternative embodiments may incorporate any subset of the components of the system. The prepaid financial system may be maintained and operated by a system provider.

The embodiment of FIG. 1 includes database 112, which is configured to store various information used to facilitate the processing of financial transactions. Illustratively, the information stored in database 112 includes accounts for registered users of the system as well as various information belonging to registered users and unregistered users participating in or requested to participate in a transaction. In general, a user account is a stored value account representing an amount of funds held on the users behalf. Account balances can be held in one or more currencies. A currency is a unit of exchange or account and is not limited to country currencies such as dollar, Euro and the like. A currency can be also an index for example based on a basket of country currencies, commodities or the like. A currency can also comprise vouchers, coupons, credits and/or other forms that represent a value amount. User information for registered and/or unregistered users may include user identifiers (e.g., name, telephone number, physical address, ID number), transaction records, account balances, preferred communication methods (e.g., electronic mail, wireless voice), account profile (personal and business information), security data, and authentication information.

In the embodiment of FIG. 1, database 112 is accessed by communication server 114 and system server 116. Only one database 112, one communication server 114 and one system server 116 are shown, but it is understood that more than one database and/or servers can be used, either individually or in a distributed manner, and that other servers providing additional functionality may also be interconnected to any component shown FIG. 1 either directly, over a LAN or a WAN, over the Internet or other kind of electronic communication.

In the illustrated embodiment of FIG. 1, communication server 114 and/or other system servers are configured to interact with one or more users through insecure communication network 130 and secure communication network 132 which has encryption protocols that prevent eavesdropping, tampering, and message forgery. Insecure network 130 may comprise a combination of public and private networks such as the Internet. Secure network 132 may comprise a physically or virtually secure network maintained by the system provider. Physically, network 130 and 132 may comprise the same networks, with secure communications encrypted using secure channels such as Secure Sockets Layer (SSL) or other cryptographic protocols that provide secure communications.

Communication server 114 may comprise: a Short Message Service (SMS) Gateway 114a for unencrypted communications over SMS on insecure communications network 130; an Interactive Voice Response (IVR) System 114b for unencrypted communications over voice (phone calls) on insecure communications network 130; and a Web server 114c for secure interactions with a web browser over the secure network 132 or insecure network 130. An insecure network presence, such as SMS Gateway 114a or IVR System 114b, that are hosted by communication server 114 may serve as a primary access points to the system for new and existing users. Illustratively, users are given PINs (Personal Identification Number) with which to access the system and/or authenticate transactions after being registered. Other and/or additional forms and/or processes of security (e.g., digital certificates, biometric devices) may be employed on a secure or insecure network. System server 116 in the illustrated embodiment is configured to handle user identity and authentication implemented at a common service level and to automate the tasks involved in ensuring a completely available infrastructure. System server 116 also provides common functionalities of the system and manages the interaction between processes. System server 116 also hosts process-centric applications, programs and/or widgets that manage specific aspects and financial transactions of the system. Such transactions include opening accounts, accepting deposits, executing transfers, clearing transactions, updating account information (e.g., reflecting cleared transactions), and the like. System server 116 is configured to interface with financial institutions 120 1 to 120 n, which may, in one embodiment of the invention, be external to the system. Thus, insurance companies, banks, micro-lending institutions and other entities that offer financial services through the system may manage their financial services on the system with contained process-centric applications installed on system server 116. System server 116 may also be configured to transfer funds through ACH 122 1 and/or other electronic networks for financial transactions such as Pan-European-ACH 122 2.

The illustrated embodiment in FIG. 1 may communicate with users through various types of transaction interfaces. Therefore, users may interact with the system by operating devices such as mobile phone 140 over SMS, phone 142 over voice, personal computer 144 over Internet and/or other electronic devices capable of communicating with communication server 114 (apparatus 146).

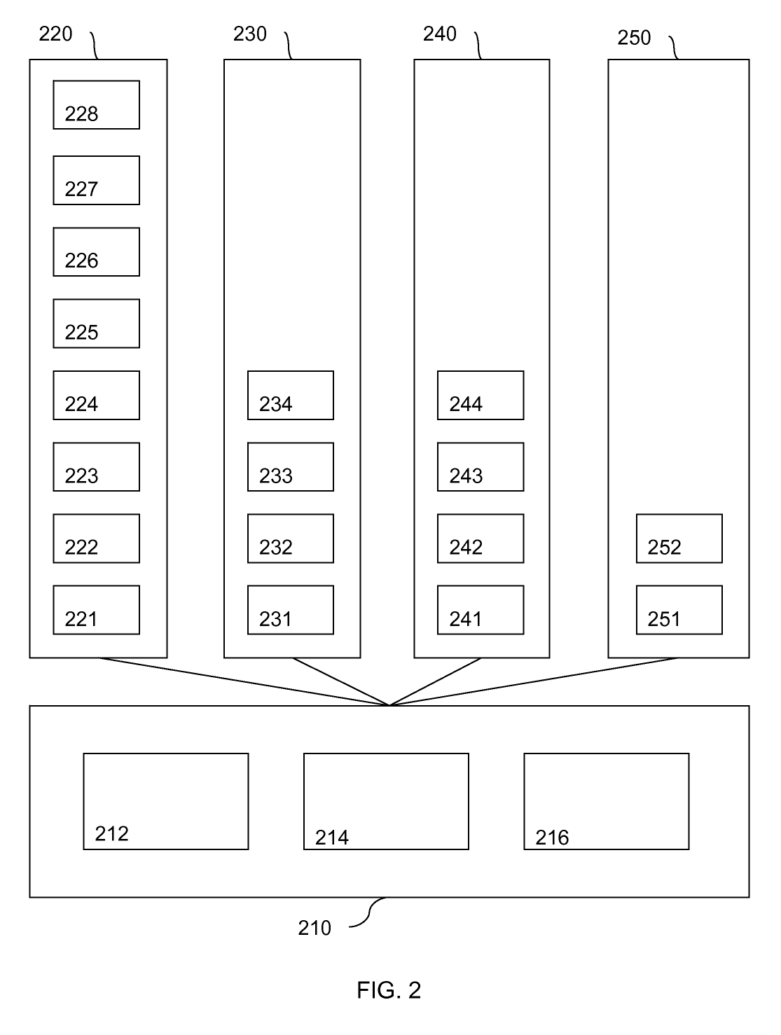

Several elements in the embodiment shown in FIG. 1 are conventional, well-known elements that need not be explained in detail here. Personal computer 144 is capable of interfacing directly or indirectly with the Internet running a browsing program, such as Microsoft's Internet Explorer and/or mobile phone 140 is able to send SMS messages. Communication server 114 and system server 116 and any related components are operator configurable using an application including computer code run using a central processing unit. Computer code for operating and configuring communication server 114 and system server 116 as described herein is preferably stored on a hard disk, but the entire program code, or portions thereof, may also be stored in any other memory device such as a ROM or RAM, or provided on any media capable of storing program code. It is presently contemplated that the embodiment of the financial system is implemented within a SOA (Service-oriented architecture) framework as shown in FIG. 2. The SOA framework is created around open accessible standards (open hardware, open database, open server applications, and the like.) and will permit the use of internal (in-house) and external (third parties) programming to further extend the functionality and flexibility of the system. Internal and external system applications, programs and/or widgets will be inserted at designated APIs (Application Programming Interface) on system server 116 illustrated on FIG. 1.

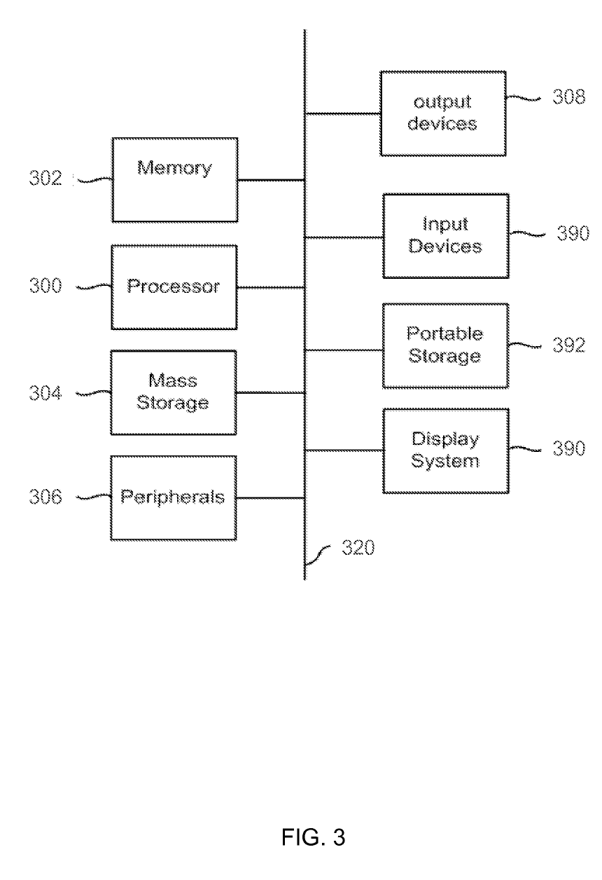

Each of the servers and personal computers may comprise a system such as that shown in FIG. 3. The computing system of FIG. 3 includes processor 300, memory 302, mass storage device 304, peripherals 306, output devices 308, input devices 310, portable storage 312, and display system 314. For purposes of simplicity, the components shown in FIG. 3 are depicted as being connected via single bus 320. However, the components may be connected through one or more data transport means. In one alternative, processor 300 and memory 302 may be connected via a local microprocessor bus, and the mass storage device 304, peripheral device 306, portable storage 312 and display system 314 may be connected via one or more input/output buses.

Processor 300 may contain a single microprocessor, or may contain a plurality of microprocessors for configuring the computer system as a multiprocessor system. Memory 302 stores instructions and data for execution by processor 300. If the technology described herein is wholly or partially implemented in software, memory 302 will store the executable code when in operation. In one embodiment, memory 302 may include banks of dynamic random access memory, high speed cache memory, flash memory, nonvolatile memory, or other storage elements. For example, memory 302 can store code to program processor 300 and can store the data representing an experiment. Processor 300 can perform the methods described herein based on the stored code and using the experiment data.

Mass storage device 304, which may be implemented with a magnetic disc drive or optical disc drive, is a nonvolatile storage device for storing data and instructions for use by processor 300. In one embodiment, mass storage device 304 stores the system software that implements the technology described herein for purposes of loading to main memory 302. Mass storage device 304 can also store the experiment data.

Portable storage device 312 operates in conjunction with a portable nonvolatile storage medium, such as a floppy disc, CD-RW, flash memory card/drive, and the like., to input and output data and code to and from the computer system of FIG. 2. In one embodiment, experiment data and system software for implementing the present invention is stored on such a portable medium, and is input to the computer system via portable storage medium drive 312.

Peripheral devices 306 may include any type of computer support device, such as an input/output interface, to add additional functionality to the computer system. For example, peripheral devices 306 may include a network interface for connecting the computer system to a network, a modem, a router, a wireless communication device, and the like. Input devices 310 provides a portion of a user interface, and may include a keyboard, or pointing device (e.g. mouse, track ball, and the like.). In order to display textual and graphical information, the computer system of FIG. 3 will (optionally) have an output display system 314, which may include a video card and monitor. Output devices 308 can include speakers, printers, network interfaces, and the like.

The components depicted in the computer system of FIG. 3 are those typically found in computing systems suitable for use with the technology described herein, and are intended to represent a broad category of such computer components that are well known in the art. The computing system of FIG. 3 can be a personal desktop computer, workstation, server, mini-computer, main frame, laptop computer, handheld computer, mobile computer, cellular telephone, television set-top box, or other computing device. Many different bus configurations, network platforms, operating systems can be used. The technology described herein is not limited to any particular computing system.

In FIG. 2, the SOA foundation into which system applications can be plugged is Common Service 210 which is hosted on system server 116 illustrated on FIG. 1. Common Service 210 comprises Security service 212, Service Management 214 and Process Management 216. Security service 212 will handle Identity, Authentication, and Authorization that is implemented at the common service level as some security elements will have to be implemented at the application level. Service Management 214 provides a common interface for managing both infrastructure and application management, alongside provisioning and helps automate the tasks involved in ensuring a completely available infrastructure. Process Management 216 provides common functionalities to applications and manages the interaction between processes.

In FIG. 2, internal and external system applications, programs and/or widgets are contained process-centric programs that are installed on system server 116 illustrated in FIG. 1. These contained process centric programs are application services that can be grouped into but not limited to the following logical application area.

An account Management Area 220 comprises a series of services 221-228 for managing and maintaining accounts. An Activate Account service 221 manages the process of creating a new accounts, of capturing the required user information such as name, address, unique user identifier, and the like. and of linking all information together. An Administer Account Transfer service 222 executes transfers from one account to another account according to user instructions. Such instructions include at least the amount and destination account, but may include the date for a deferred transfer, recurrent transfers, and the like. An Administer Account Details service 223 allows the system operator to edit and add information pertaining to the user and his account. In one embodiment, the user is not able to directly edit this data. A Terminate Account service 224 manages the process of eliminating an account on the system. An Administer Deposit service 225 manages the process of identification of a deposit and of crediting the deposit amount to the relevant account. An Administer Withdrawal service 226 manages the process of identification of a withdrawal and of debiting the withdrawal amount to the relevant account. An Apply Account Fees service 227 enables to create new fees and edit existing fees charged to users of the system. Fees service 227 also processes and deducts these fees from accounts. Fees service 227 may charge automatically recurrent fees such as minimum balance or maintenance fees or one time fees for a specific event, for example for a transaction. Finally, an Account Statement service 228 shows an account's current balance and transactions during a specific period of time.

A Relationship Management area 230 comprises a series of services 231-234 for managing relationships with system users. An Administer Account Information service 231 allows a user to edit and add an account profile to his account. Such a profile may comprise information about the user's business, willingness to sell goods and services using the system, and the like. and may be searchable by other users if allowed by the user. A Develop Account Opportunity service 232 allows system operators to analyze account transactions and balances to identify and sell other financial products that may be suitable to the account user. A Promote Account Use service 233 allows system operators to identify dormant or low activity accounts and encourage the use by ways of mailings, direct contacts and the like. A Search Account Information service 234 lets users search other user's profiles.

A Risk & Compliance Management Area 240 comprises a series of services 241-244 for managing risk and regulatory compliance of the system. A Record Retention Policy service 241 establishes the time frame for the retention of transaction information and records/stores the information for the specified time. In addition, an Establish Maximum Daily Value Policy service 242 lets system operators set a maximum transaction amount for a specific account on a determined period of time. If this limit is surpassed the system will prevent the transaction. An Establish Maximum Account Balance Policy service 243 lets system operators set a maximum account balance on a specific account. If this threshold is exceeded the system will stop the transaction. A Regulatory Reporting service 244 allows system operators to capture relevant financial information of the system and create reports to be filed with regulatory authorities.

A product area 250 comprises a series of services 251-252 for providing financial services and products to system users. A Credit service 251 allows credit service providers manage credit policies, such as type of credit, interest rates, minimum payment requirements, maximum credit amounts, and the like. Credit service 251 also creates credit accounts and links them to users' main accounts once credit is granted. Credit service 251 may also monitor repayments. A Savings Account service 252 manages saving account policies, such as interest rates, minimum balance requirements, maximum transaction amounts, and the like. Savings Account service 251 also creates savings accounts and links them to main account of users.

The aforementioned application services and application areas are shown to serve as examples, but it should be understood that many more areas and application services are possible.

The SOA framework of the embodiment of the financial system as illustrated in FIG. 2 is one implementation of the framework. However for those skilled in the art, other forms within a SOA as well as other types of architectures will be apparent.

The embodiment of the financial system enables the creation and maintenance of stored value accounts on behalf of account holders. Each account represents an amount of funds hold in a currency and facilitates the underlying transactions of financial products present in the system. A financial product transaction can be reduced after simplifying its complexity to one or a series of transfers of stored values from one account to one or more accounts conditioned by predetermined parameters and/or user actions that may trigger or block them.

A currency is a unit of exchange or account and is not limited to country currencies such as dollar, Euro and the like. A currency can be also an index for example based on a basket of country currencies, commodities or the like. A currency can also comprise vouchers, coupons, credits and/or other forms that represent a value amount.

The embodiment of the pre-paid financial system clears transactions only if sufficient funds are available to sustain the transaction. The balance of the origination account must be equal or greater than 0 after debiting the amount of funds to be transferred, charges and other fees that may be applicable to the transaction.

The embodiment of the pre-paid financial system is also closed and centralized. A closed system occurs when the fund transfer takes place under the control of the entity who owns and/or manages the financial system and is independent of other systems such as credit card networks, an ACH (Automated Clearing House) or the like, to operate. In this context, a centralized system means that the system is located in and/or managed from one place (e.g. region, country, etc).

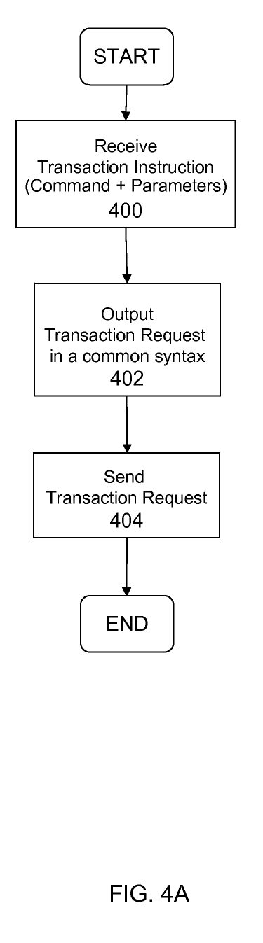

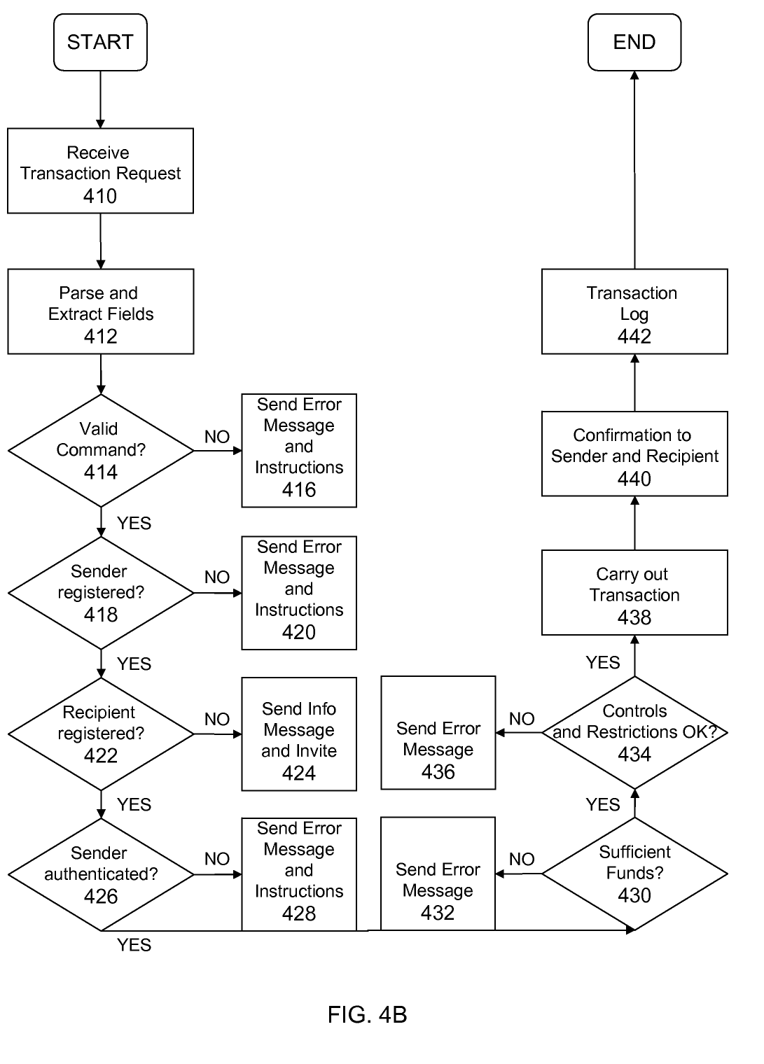

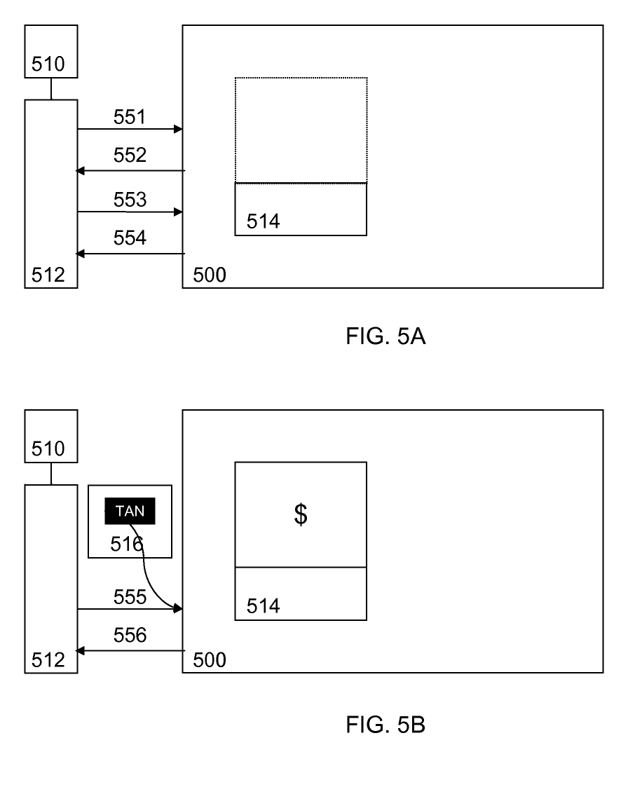

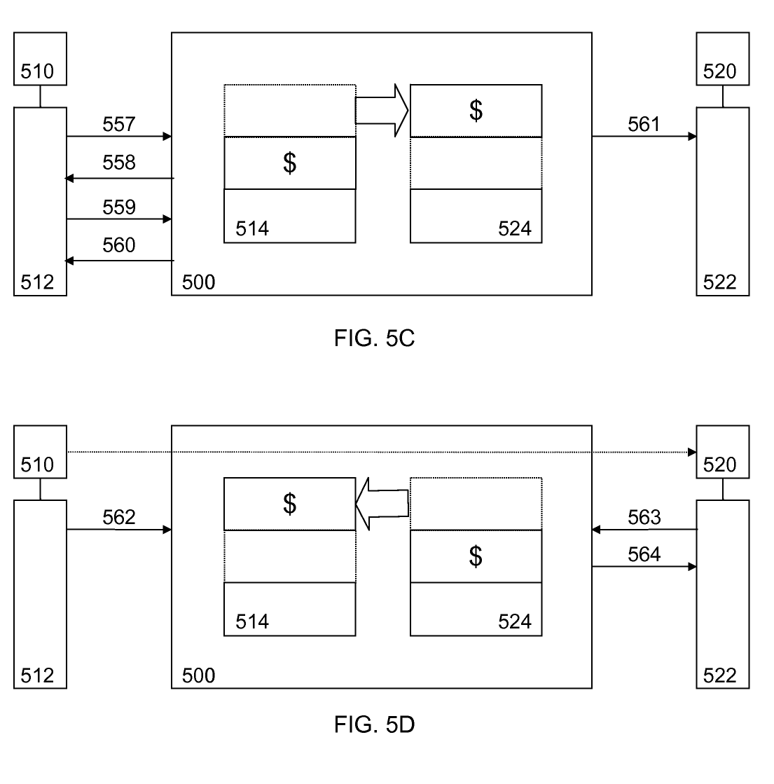

To enable transactions on the system, at least one user must open an account as described below at FIG. 5A. Once an account is established, transactions can be processed as described in FIG. 4A and FIG. 4B.

FIG. 4A is a flowchart showing an exemplary transaction processing method on the front end of the embodiment of the financial system. FIGS. 4A and 4b illustrate a transaction process after the account is established. The process for establishing an account is illustrated in FIGS. 5A-5D.

As shown in FIG. 1, users interact with the system using a plurality of devices such as mobile phone 140, phone 142, personal computer 144 and other electronic devices (apparatus 146) with different kinds of transaction interfaces that however use common standards and procedures. This makes it possible for users to employ all transaction interfaces in the basically the same and intuitive manner without having to learn new skills. The transaction interfaces may comprise but are not limited to, SMS Text Messages, Web Browsers and Software Programs and are illustrated in detail after this Transaction Processing section.

At step 400, a transaction interface receives a user input that includes a transaction instruction with at least a command and respective parameters of a transaction.

For example, a user may compose using the SMS Text Message function of his/her mobile phone a transaction instruction written according to a predetermined syntax. Assuming in this example that the user wants to transfer funds from his/her account to another (destination) account, the SMS Text Message could take the following format: “send <amount> to <destination account>”.

In another example, if the user wants to initiate the same fund transfer, this time using a web browser as a transaction interface, he would be presented with a web page that allows him to input the same information: “send <amount> to <destination account>”

The transaction interface outputs in step 402 the transaction request in a common syntax independent of the used transaction interface. Such a common syntax typically comprises the following fields:
transaction commands that define the type of transaction to be initiated. For example the command “send” defines a fund transfer.
transaction parameters that parameterize and/or condition a given transaction command. For example the parameters “<amount>” and “to <destination account>” after the transaction command “send” indicate the value amount and the account where the funds should be transferred.
a authentication token that positively links the user to a transaction request. For example a mobile phone number could be used as a authentication token
an user token with which a user confirms a transaction request as authentic. For example such a user token could be a PIN given to a user.

More fields such as transaction suffixes can be added to increase the functionalities of the system.

At step 404, the transaction interface transmits the transaction request to the financial system. As heretofore described, the SMS Text Message Transaction Interface sends the transaction request over an insecure communications network whereby the Web Browser Transaction Interface and the Program Software Transaction Interface commonly use a secure communications network.

FIG. 4B is a flowchart showing an exemplary transaction processing method on the back end of the embodiment of the financial system. Transaction processing as illustrated in FIG. 4B may occur on database 112, communication server 114 and system server 116 illustrated in FIG. 1. At step 410, a transaction request is received, e.g. a request to transfer funds from one account (origination account) to another (destination account).

As heretofore noted, the transaction request is initially received by communication server 114 which classifies and routes it to system server 116, both illustrated in FIG. 1.

The transaction request is parsed and its fields (transaction commands, transaction parameters, user token and/or authentication token) extracted at step 412. The fields are then stored for further analysis. The parsing can occur in communication server 114 or in system server 116 (after the transaction request has been forwarded) shown in FIG. 1. If a transaction command is invalid (step 414), an error response may be returned to the user (step 416). The error message indicates that the transaction request was not processed, and provides a reason and a solution.

If the transaction command in the transaction request is valid, the system first positively identifies the user of origination account (sender) in step 418. This step involves checking the sender's authentication token (e.g., name, telephone number, physical address, ID number) received with the command against a list of active authentication tokens in the system. If the authentication token does not match any of the active authentication tokens, the system sends the user an error message (step 420). Such a message could be formatted as follows:

“We couldn't find your account in our records; please open an account today.”

The user of destination account (recipient) is then checked in the system (step 422), and if the destination account does not appear in the system (determined, with the same methods illustrated in step 418) an invitation will be sent to the proposed recipient, inviting that person to register with the system (step 424). In such a situation, the transaction is put on hold, and the message to the recipient may indicate that the transaction is cleared by signing up with the system. The message to the sender takes, for example, the form of:

“<recipient> is not yet registered; funds will remain on hold until you cancel and/or he/she registers.”

When funds are held, the system also creates an account for the recipient and, and provisionally assigns any funds on hold to that account, pending registration and PIN assignment by the recipient, or cancellation by the sender.

In step 426, the system sends an authentication request to the sender, and will not carry out the transaction unless the user makes such an authentication. The authentication request may involve an electronic message or other forms of communication asking the sender for his/her user token (PIN).

Alternatively, the system may require to include the user token (PIN) with the original transaction request and could look for such information in the original request and authenticate the sender without sending a return message to the sender asking for verification.

Alternatively, the authentication may include a call to the sender, followed by a prompt for the user to key or speak a password, PIN, or similar entry. In addition, a voiceprint or other identifying characteristic of the user may be employed for such authentication.

Also, the complexity of the authentication may change with the type and/or amount of the transaction. For example, authentication may waived or simple requirements may be imposed for low-value and/or repetitive transactions. Alternatively, more complex, and perhaps multiple-part authentication may be required for high-value and/or exceptional/out of the ordinary transactions. Information from the authentication, such as a digital recording of an oral approval by the user, may also be saved by the system for follow-up, e.g., if the transaction is challenged by the user.

If sender could not be correctly authenticated the system sends an error message and instructions to resubmit his/her pin (step 428). The message to the sender takes, for example, the form of:

“Your PIN is incorrect, please try again”.

In case of repeated incorrect authentications attempts, the system can stop the transaction process and/or block the originating account for a specific or indeterminate period of time so as to prevent suspicious or fraudulent activities.

The level of funds held by the sender is then checked in step 430. This check involves determining whether the origination account has sufficient funds to sustain the transaction: the originating account balance must be equal or greater than 0 after debiting the amount of transferred funds and charges as well as other fees that may be applicable to the transaction. If the origination account does not have sufficient funds, the system send an error message to the sender (step 432). This error message can take the form for example of:

“We are sorry, insufficient funds for this transaction”.

In step 434, the system then monitors and enforces banking and AML (Anti-Money Laundering) regulations and best practices. The system may prevent for example a number of transactions and/or monetary value in a given period of time, maximum account balances, and the like. In addition, other checks may be run, such as a fraud check that involve comparing the pending transaction against a profile for the particular user's earlier payment activities.

Other restrictions and/or rules may apply preventing a transaction. For instance, a particular sender may have a restriction that permits for transactions of up to a specific monetary value. Even if the sender has sufficient funds in his/her account to sustain the transaction and all other rules are met, if he/she seeks to transfer a higher amount the system may prevent the transaction.

If restrictions apply the sender is informed about the nature of these (step 436). Such a message could be formatted as follows:

“We couldn't process your request; <applied restriction>.”

In step 438, the system executes the transaction, in this example the transfer of funds from the origination account to the destination account. The system debits from the origination account the funds requested in the transaction command and credits them to the destination account. The system may also debit other applicable charges and fees related to the transaction. Other suitable processes to transfer funds may be used as well.

When the transaction has been completed, the sender and/or recipient are notified in step 440. The message to the sender takes, for example, the form of:

“Confirmation: <recipient> received <fund amount> from you”.

The message to the recipient can for example be:

“You received <fund amount> from <sender>”.

In step 442, information about the transaction is added to a transaction log on database 112 in FIG. 1. In addition, transaction information is stored for the sender and the recipient. Pointers from the sender's and recipient's data may also be provided to database 112 in FIG.

This is one example of a plurality of a possible financial transaction processing method. Other orders as of steps, algorithms and processes as well as additions and elimination thereof can be created as is appropriate or necessary to carry-out or complete any type of financial transactions.

In one embodiment of the pre-paid financial system, a user initiates a transaction process with the composition of a transaction instruction in the form of an SMS text message with predetermined syntax that includes at least a transaction command, the related transaction parameters and an authentication token. The user then sends the composed message with his/her mobile phone via an insecure network to the SMS Gateway of the financial system. The message is received by the system and the transaction processed as heretofore illustrated in FIG. 4.

FIG. 5A to FIG. 5D are schematic diagrams showing examples of possible messages flows.

FIG. 5A shows an example of a message flow for an account activation. In FIG. 5A User 510 has device 512 and wants to use pre-paid financial system 500. Device 512 can be, for example, a mobile telephone, smartphone, or any other device enabled to send SMS text messages and to have caller ID. In order to be able to use system 500, User 510 needs to register and activate an account within system 500. User 510 would then compose on device 512 a command generated as a part of a text message. The message can take the following format:

“activate <user 510 name> <user 510 address> <user 510 Date of Birth>”.

In a next step, device 512 transmits the composed message 551 to the SMS gateway number of system 500. The command is then processed by system 500 as a request for account activation. During the account activation, a new account is associated with the authentication token determined by device's 512 unique caller ID number (account 514). All other information received with the activation message, such as user 510 name, user 510 address, user 510 Date of Birth, is stored and associated with account 514.

In order to finalize the account activation request, the system sends confirmation message 552 to device 512 and asks user 510 for a PIN that will serve as user token to authenticate future transactions. The positive identification of user 510 is done by matching the authentication token (device's 512 caller ID number) with the activated account 514 and the user token (PIN of user 510), but other methods can be used as well. Message 552 could take the following format:

“Thank you, please submit now your four digit PIN to finalize account activation”.

User 510 then writes and sends his PIN in a second message (message 553) to system 500. Such a message could take for example the format:

“PIN <user 510 PIN number>”.

The system receives the message and associates the PIN with account 514. System then sends back message 554 to device 512 confirming user 510 that the account has been activated. Such a message can take the form:

“Thank you, your account has been activated”.

FIG. 5B is a diagram showing an example of a possible message flow of a fund deposit on an active account. Users are able to deposit funds on their account with a plurality of processes, operations or methods, either computer enabled or not. One of such methods is the use of fund-cards issued for a specific value by the administrator of the pre-paid financial system. A user could buy these fund-cards and credit the value of the bought fund-card to his account with methods common today, for example with an unique and hidden Transaction Authentication Number (TAN) that is able to link the value of the card to the person that revealed it.

In FIG. 5B user 512 writes on device 512 and sends message 555 to pre-paid financial system 500 to effect a deposit of funds on his account 514. In this exemplary financial transaction, the user has already bought fund-card 516 of system 500 and revealed its hidden TAN. Text message 555 can take the following format:

“Deposit <TAN>”.

Message 555 is received and processed by system 500. The TAN allows with methods common today and processes heretofore described to link the value of fund-card 516 to account 514. Once the value is credited to account 514, message 556 is send to device 512 confirming the deposit. Message 556 can take the form:

“Thank you, <value> has been deposited to your account>.

FIG. 5C is a diagram showing an example of a possible messages flow of a fund transfer. In FIG. 5C user 510 writes on device 512 text message 557 and sends it to system 500 to effect a transfer of funds from his account 514 to account 524 of user 520. In this exemplary financial transaction, it is assumed that user 520 has already activated account 524 with the procedure illustrated in FIG. 5A. Message 557 can take the following format:

“send <amount> to <user 520 device 522 number or other ID>”.

For example, if user 510 wants to send five dollars to a person whose mobile number is 123-555-6789, he thus would write text message 557 as follows:

“send 5 to 123-555-6789”.

Message 557 is then processed as illustrated in FIG. 4A and FIG. 4B: PIN request to user 510 (message 558), PIN input from user 510 (message 559) and confirmations to user 510 (message 560) and user 520 (message 561).

Alterations of syntax, transaction commands, transaction parameters and transaction suffixes of the text message can provide the necessary flexibility to carry-out all sorts of financial transactions and variations thereof. For example, a fund transfer such as the transaction illustrated in FIG. 5C can be altered to limit the information conveyed in the confirmation message for security purposes. User information about a fund sender, such as a cell phone number could be withheld from fund recipient so as to prevent recipient from having more information than may be necessary about the sender. In this case only the amount of funds added to the recipient's account is shown. In this case a transaction suffix is added to the standard message:

“send <amount> to <ID number of recipient's device> no info”.

In addition, sender may choose to transfer funds to multiple people using a single message. The syntax of the message sent for such a multiple transfer, could be for example:

“send <amount> to <ID number of sender's device> <ID number of first recipient's device> <ID number of second recipient's device>”.

SMS text messages to begin a transaction may also allow to send a user's PIN. In this case, the message can take for example the form of:

“send <amount> to <recipient's device number> PIN <sender's PIN>”.

Other information may be optionally transmitted using transaction suffixes. For example, a message may be added to the command so that recipient can reference the payment with this additional information. The message could be for example:

“send <amount> to <recipient's device number>+info <additional information>”.

Furthermore, currency conversions may be provided as part of a transaction. For example, sender could be a migrant in the US and instructs a transfer in a particular currency to a recipient who is overseas. Such a message would add an additional transaction parameter and take the form for example of:

“send <three letter currency code> <amount> to <recipient's device number>.”

The system then makes the conversion to the current exchange rate, debits the equivalent dollar amount from the sender's account and credits the foreign currency amount to the recipient's account. The Financial System uses available location data about its users (e.g., mobile carrier information) to default to the currency local to the user initiating a transaction. For example, if sender is living overseas and instructs a payment to a recipient in the US, the transaction would default to the foreign currency. In such a situation the standard message message without the currency code, such as “send <amount> to <recipient's device number>” would be carried out in the foreign currency. If the overseas sender wishes to carry out the transactions in US dollars he/she needs to specify it in the message with the three letter currency code “USD” for US dollars.

As heretofore mentioned, accounts can also have an account profile comprising personal and business information about a user. This profile information can be edited anytime by the account holder and is searchable by other users of the system. Such an account profile information may comprise for example the user's disposition to deposit cash in his/her account. This information is valuable as it may provide system users with additional sources of cash deposits and withdrawals. Another example of relevant account profile information could be user business details such as goods/services sold, location, acceptance of system payments (a transfer of funds as heretofore illustrated) and the like. This business information would allow for example a street market vendor feature his/her stand on the system, show the type of products he/she sells and display the readiness to accept payments within the system.

FIG. 5D shows an example of a message flow for a user adding information to his/her account profile and how it can be searched by other users of the system. In FIG. 5D User 510 has device 512 and wants to add to his account profile information about his disposition to deposit cash to his/her account on pre-paid financial system 500. In FIG. 5D user 510 writes on device 512 text message 562 and sends it to system 500 to add information about his willingness to deposit cash in his/her account 514. Message 562 can take the following format:

“cash <amount> <location>”.

For example, if user 510 wants to deposit five dollars, he thus would write text message 562 as follows:

“cash 5 Palo Alto Calif.”

In FIG. 5D User 520 has device 522 and wants to withdraw cash from his/her account on pre-paid financial system 500. In FIG. 5D user 520 writes on device 512 text message 563 and sends it to system 500 to search for users who want to deposit cash to their account. Message 563 can take the following format:

“search cash <amount> <location>”.

For example, if user 520 wants to withdraw five dollars and is in Palo Alto Calif., he thus would write text message 563 as follows:

“search cash 5 Palo Alto Calif.”

System 500 would then search for possible matches to the query and would send text message 564 to user 520 with the result list. Such a message could be formatted as follows:

“The best matches for your query are <result list>.”

Adequate safeguards will be implemented to prevent illicit or criminal activities. These may include but are not limited to anonymizing query results, excluding users from the system, keeping search records and the like. When user 510 and user 520 meet, user 510 hands over the cash to user 520 and user 520 makes a fund transfer for the same amount to account 514 of user 510.

Conventional web and software programming techniques can be implemented so that users can add information to his/her account profile and search other account profiles via other interfaces, such as but not limited to a browser interface and/or software program interface. Conventional searching techniques may be used whereby one or more of the system servers maintains a secure index searchable by a conventional search engine accessible by a browser based or dedicated client software based search interface.

These are some examples of a plurality of possible financial transactions that can be carried out using SMS text messaging. The instructions for a transaction are generated as part of a text message having a predetermined syntax that includes transaction commands, transaction parameters, transaction suffixes, and user and authentication tokens. Other orders of syntax, commands, parameters, suffixes and tokens additional messages and message parts as well as changes of transaction processes can be generated as is appropriate or necessary to carry-out or complete any type of financial transactions.

In an additional embodiment of the pre-paid financial system, a user initiates a transaction process with a personal computer, cell phone, smart phone or any other device capable of interfacing directly or indirectly with the Internet running a browsing program (browser), such as Microsoft's Internet Explorer and connecting to Communication server 114 illustrated in FIG. 1.

A user typically accesses Server 114 by selecting or entering on the browser the URL identifying server 114. When accessed, server 114 provides the user with one or more web pages formatted according to downloaded Javascript code, HyperText Markup Language HTML, Extensible Hypertext Markup Language (XHTML) and/or Wireless Markup Language (WML) code and data as is well known. In general, any Standard Generalized Markup Language (SGML) as well as other standards such as, but not limited to Cascading Style Sheets (CSS), extensible Style Sheet Language Transformations (XSTL), extensible Markup Language (XML), asynchronous JavaScript and XML (AJAX), Wireless Markup Language (WML), Adobe Flex, Flash, and the like. may also be used. On these Web pages, a user is able to compose the necessary commands for the pre-paid financial system to process the transactions as heretofore illustrated in FIG. 4.

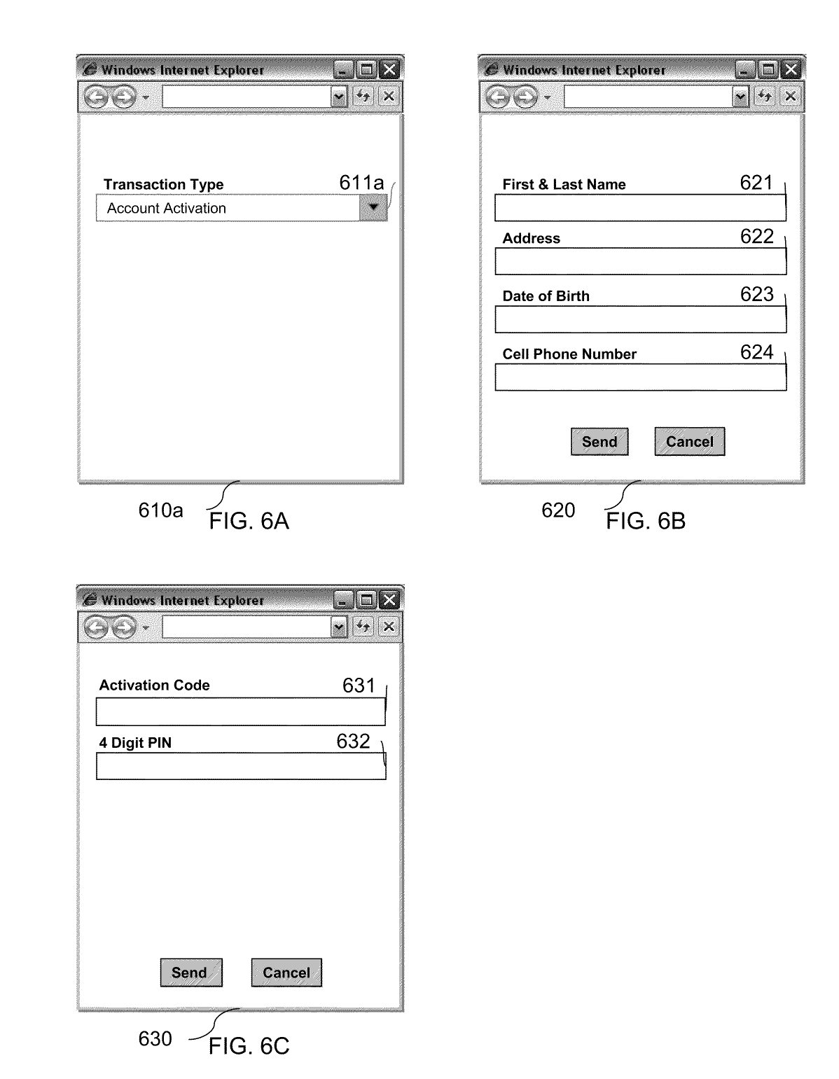

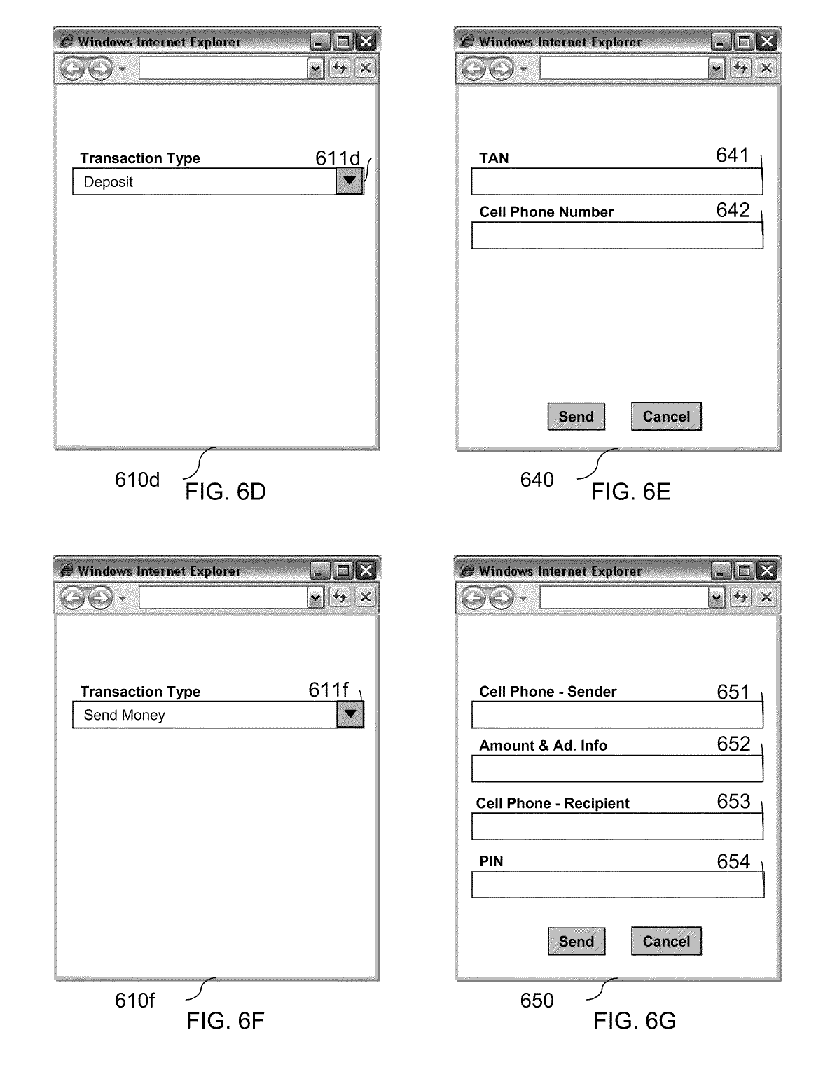

FIG. 6A to FIG. 6G are examples of browser generated transaction instructions. FIG. 6A, FIG. 6B and FIG. 6C illustrate an example of an account activation using a browser.

On FIG. 6A a user is presented with web page 610a that includes field 611a after entering on a browser a URL used by the financial system to initiate financial transactions. Field 611a on FIG. 6A allows the user to select the desired transaction type from a list presented on a pull-down menu. Once the user selects “Account Activation” from the menu, he/she is shown a web page that for example can take the form of page 620 illustrated in FIG. 6B. The user enters his/her first and last name in field 621, address in field 622, date of birth in field 623 and mobile phone number in field 624 and clicks on the Send button to send the transaction commands to the financial system or the cancel button to abort the transaction processing and get back to page 610a shown in FIG. 6A. It is presently contemplated that after the user clicks on the send button, the system stores the transmitted user information and generates an unique and random activation code that is send to the user's mobile telephone, smart-phone, or any other device enabled to receive a SMS text messages from the financial system. This process during registration and activation allows the system to positively associate a new account with an authentication token, but other association and identification methods can be used as well, such as the user presenting phone bills, and the like.

The system then loads page 630 depicted in FIG. 6C where the user enters the received activation code and his/her user token (PIN) in field 631 and field 632 respectively. After the user clicks on the send button, the system activates the new account and sends a confirmation message. Such a message can take the form:

“Thank you, your account has been activated” and can be send to the user's device as an SMS message and/or displayed in a web page on a browser (not shown in FIG. 6A, FIG. 6B and FIG. 6C).

FIG. 6D and FIG. 6E illustrate an example of a deposit executed with the browser interface. Field 611d on page 610d shown in FIG. 6D allows the user to select the desired transaction type from a list presented on a pull-down menu. Once the user selects “Deposit” from the menu, he/she is shown a web page that for example can take the form of page 640 illustrated in FIG. 6E. In this exemplary financial transaction, it is assumed that the user has bought a fund-card and revealed its hidden TAN. The user introduces the revealed TAN in field 641, a cell phone number in field 642 and clicks on the send button. Once the value is credited to the account associated with the cell phone number, a message is send to the phone via SMS and/or displayed on a web page (not shown in FIG. 6D and 6E) confirming the deposit. The message can take the heretofore shown forms.

FIG. 6F and FIG. 6G are another example of a possible set of web pages of a transaction instruction. A user selects on field 611f of web page 610f shown in FIG. 6F the transaction type “Send Money” from the pull-down menu options and is taken page 650 depicted in FIG. 6G. The user (sender) writes in field 651 his/her authentication token which can be the cell phone number associated with his/her account. In field 652 he/she writes/selects the transaction commands, transaction parameters and transaction suffixes following the syntax and rules heretofore illustrated. As with the SMS interface, these transaction instructions could include for example, currency code, show additional information or withheld user information, and the like. On field 653 he/she introduces the cell phone number associated with the recipient's account and on field 654 his/her PIN to authenticate the transaction. The user then clicks on the send button so that the transaction interface submits the transaction request for processing by the system. The system processes the request as heretofore illustrated in FIG. 4 and sends the respective messages to sender and recipient via SMS and/or displays a web page to the sender (not shown in FIG. 6F and FIG. 6G).

As heretofore mentioned, accounts can also have an account profile comprising personal and business information about a user. This profile information can be edited anytime by the account holder and is searchable by other users of the system. Users can add and/or edit their account profile information and search for other user profiles using a browser with the same principles that were described in FIG. 6A to FIG. 6G. A user would select the adequate transaction command (for example “cash” and “search cash” as illustrated in FIG. 5D) and input relevant transaction parameters (for example “5” and “Palo Alto Calif.” as shown in FIG. 5D) and transaction suffixes, and the system would process the request accordingly.

Other types and number of pages, fields, syntax, transaction commands, transaction parameters, and transaction suffixes, additional messages and message parts as well as changes of transaction processes can be modified, regrouped and/or generated as is appropriate or necessary to carry-out or complete any type of financial transactions.

Although the embodiment illustrated in FIG. 6A to 6G is being described as using pull-down menus and static pages, it is not intended that the embodiment is limited to this type of web page construction. Modifications within the spirit of the embodiment will be apparent to those skilled in the art. For example, different types of web development techniques can be used for creating interactive web applications or rich Internet applications that can retrieve data from the server asynchronously in the background without interfering with the display and behavior of the existing page. In such web development techniques, a sequence of pages as the examples illustrated in FIG. 6A to FIG. 6G would be unnecessary. In this alternative technique, for example if a user selects an option from the pull-down menus of fields 611a, 611d and 611f, the subsequent fields 621 to 624, 641 to 642 and 651 to 654 would be presented to the user in the same first page 610a, 610d and 610f (making the loading of subsequent pages 620, 640 and 650 unnecessary). It is also conceivable that a user would not need to be presented first with a pull-down menu to select an option from array of transactions and then with the related fields to be filled out. Among other possibilities, a user may write in only one field the transaction commands and the system guides and assists him/her through the composition by predicting and suggesting the syntax, other transaction commands, transaction parameters, and/or transaction suffixes necessary to initiate and complete a transaction.

Another additional embodiment of the pre-paid financial system makes use of proprietary software programs to input transaction instructions, and output and send a transaction request to the system. In this embodiment, the entity who owns and/or manages the financial system develops and makes available the software programs that for example can take the form of: plug-ins and widgets that interact with a host application, such as a web browser, and/or applications that employ the capabilities of a device directly and thoroughly.

The software programs may be installed on user's devices such as cell phones, smart phones, personal computers and/or any other communication devices capable of running these programs and actively connecting to the system for example via SMS, Internet or other kind of electronic communication.

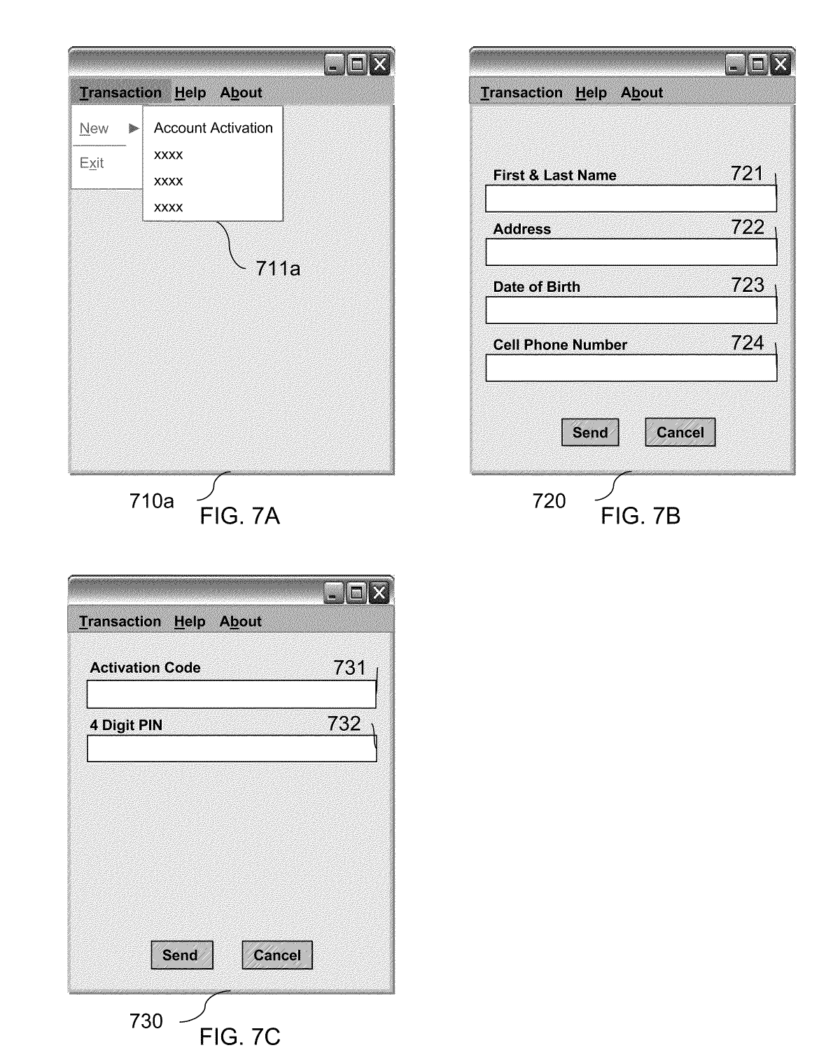

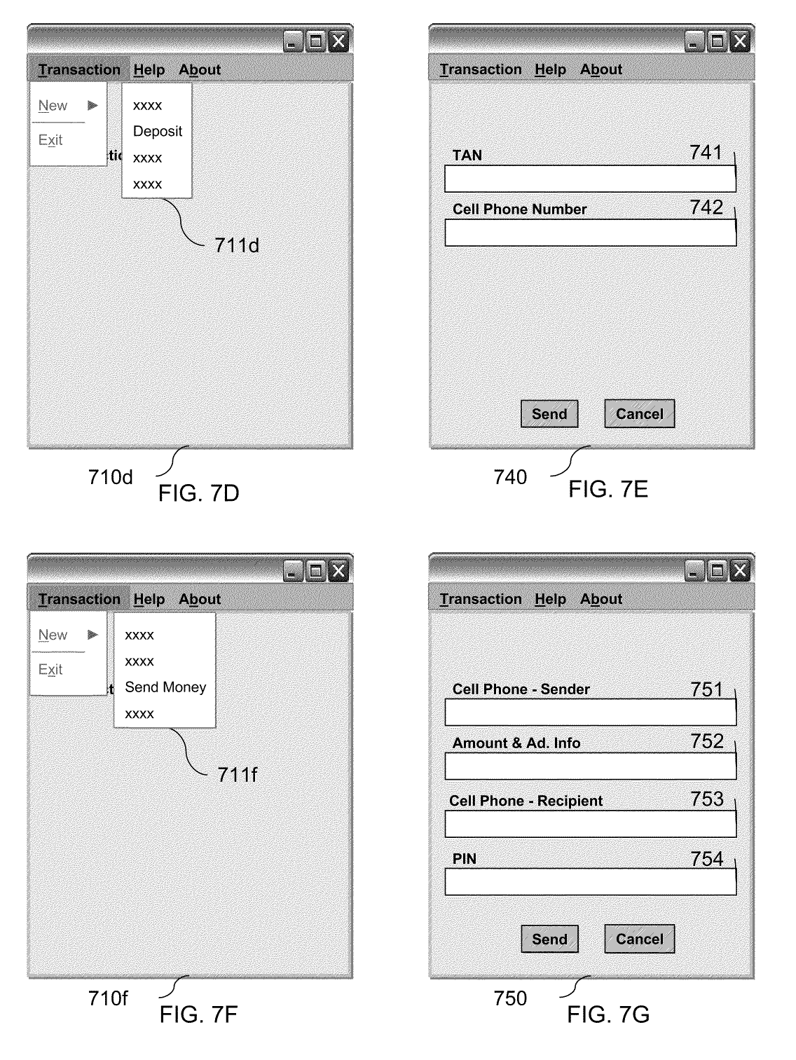

FIG. 7A to FIG. 7G are examples of software program generated transactions.

FIG. 7A, FIG. 7B and FIG. 7C illustrate an example of an account activation using a program.

After executing the program, a user is presented with program interface 710a that includes menu 711a as shown in FIG. 7A. Once the user selects “Account Activation” from the Transaction/New menu, he/she is shown an interface that can take the form for example of interface 720 illustrated in FIG. 7B. The user enters his/her First and Last Name in field 721, Address in field 722, Date of Birth in field 723 and Cell Phone Number in field 724 and clicks on the Send button to output and send the transaction request to the financial system or the cancel button to abort the transaction request processing.

The program then loads interface 730 depicted in FIG. 7C where the user enters the activation code sent to his mobile phone on field 731 and his/her PIN on field 732. After the user clicks on the send button, the system activates the new account and sends a confirmation message. Such a message can take the form:

“Thank you, your account has been activated” and can be send to the user's device as an SMS message and/or displayed in a window on the program interface (not shown in FIG. 7A, FIG. 7B and FIG. 7C).

FIG. 7D and FIG. E are an example of a deposit executed with the software program interface. Field 711d on interface 710d shown in FIG. 7D allows the user to select a new transaction on a transaction menu shown on the top left of the page. Once the user selects “Deposit” from the Transaction/New menu, he/she is shown a page that for example can take the form of interface 740 illustrated in FIG. 7E. In this exemplary financial transaction, it is assumed that the user has bought a fund-card and revealed its hidden TAN. The user introduces the revealed TAN in field 741, a cell phone number in field 742 and clicks on the send button. Once the value is credited to the account associated with the cell phone number, a message is send to the phone via SMS and/or displayed in a window on the program interface (not shown in FIG. 7D and FIG. 7E) confirming the deposit. The message can take the heretofore shown forms.

FIG. 7F is another example of possible financial transactions executed with a software program. A user selects on menu 711f of interface 710f shown on FIG. 7F the transaction type “Send Money” and is shown interface 750 depicted in FIG. 7G. The user (sender) writes in field 751 the cell phone number associated with his/her account. In field 750 he/she writes the amount and other instructions following the syntax including transaction commands, transaction parameters and/or transaction suffixes according to the rules heretofore illustrated. As with the SMS interface, these could be for example, currency code, show additional information or withheld user information, and the like. On field 753 he introduces the cell phone number associated with the recipient's account and on field 754 his/her PIN to authenticate the transaction. The user then clicks on the send button to submit his/her transaction request for processing by the system. The system processes the request as heretofore illustrated in FIG. 4 and sends the respective messages to sender and recipient via SMS and/or displays in a window on the program interface (not shown in FIG. 7F and FIG. 7G).

As heretofore mentioned, accounts can also have an account profile comprising personal and business information about a user. This profile information can be edited anytime by the account holder and is searchable by other users of the system. Users can add and/or edit their account profile information and search for other user profiles using a software program with the same principles that were described in FIG. 7A to FIG. 6G. A user would select the adequate transaction command (for example “cash” and “search cash” as illustrated in FIG. 5D) and input relevant transaction parameters (for example “5” and “Palo Alto Calif.” as shown in FIG. 5D) and transaction suffixes, and the system would process the request accordingly.

The foregoing description illustrates examples of a plurality of possible financial transactions that can be carried out using a software program. Other types and number of menus, fields, syntax, transaction commands, transaction parameters and/or transaction suffixes, additional messages and message parts as well as changes of transaction processes can be changed, regrouped and/or generated as is appropriate or necessary to carry-out or complete any type of financial transactions.

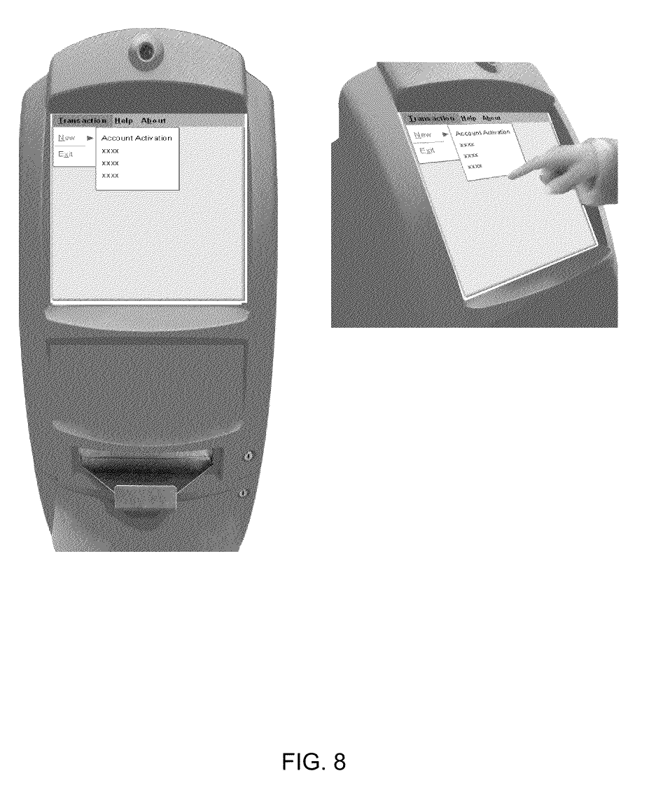

An alternative embodiment of the pre-paid financial system comprises an apparatus able to input, and output and send transaction requests to carry out transactions on the system. An example of such an apparatus is illustrated in FIG. 8. A number of well known components are illustrated in FIG. 8 and are known to one of average skill. The hardware is capable of
interfacing directly or indirectly with the Internet,
running a software program interface as heretofore illustrated and may be as well able of operating a browser,
and/or sending and receiving SMS messages, connecting to the Internet and/or establishing other kind of communication.

The hardware and any related components could be operator configurable using a software program including computer code run using a central processing unit. Computer code for operating and configuring the hardware as described herein is preferably stored on a hard disk or flash memory, but the entire program code, or portions thereof, may also be stored in any other memory device such as a ROM or RAM, carrier wave or provided on any media capable of storing program code. Exemplary forms of carrier waves may take the form of electrical, electromagnetic or optical signals conveying digital data streams along a local network or a publicly accessible network such as the Internet. For user input, the apparatus may use a plurality of commonly used input devices, such as keyboard, touchscreen, mouse, trackball, and the like.

An alternative embodiment may incorporate any subset of the components or characteristics as deemed necessary and may have any size, for example small such as a hand-held device or big such as an ATM.

It is presently contemplated that the apparatus can be placed at strategic locations, for example in high traffic locations such as conveniences stores, kiosks, and the like. to have outlets to initiate and complete any financial transaction with the system.

From the description above, a number of advantages of some embodiments of the pre-paid financial system become evident. The closed and centralized computer enabled system will establish a truly global financial transaction platform for financial services.

The closed and centralized computer enabled system will allow low cost international and local transactions as it is independent of other systems such as credit card networks, ACH, and the like.

Further, because users are required to pre-pay for account transactions using account funding means similar to those used in pre-pay phone system, this lowers the risk to the financial system and therefore the costs of financial transactions. Moreover, the service architecture provides a completely extensible environment that can re-use and repurpose infrastructure and that can be seamlessly scaled to handle a growing quantity of small accounts and transactions in a cost efficient manner.

Optionally, open source standards are used in the service architecture enabling easy and inexpensive customization of existing financial services and the creation of new offerings targeted at unbanked and other undeserved customers.

A number of common electronic devices, technologies and communication types makes it possible to provide a front end infrastructure to initiate and complete transactions that is versatile, scalable, inexpensive and available everywhere. The interactions with the system across all transaction interfaces use common standards and procedures. This makes it possible for users to employ all transaction interfaces in the basically the same and intuitive manner without having to learn new skills.

In yet another alternative embodiment, a secure ATM network and an apparatus able to transmit commands to, interact with and carry out transactions on the system and that has the functionalities of an ATM for cash deposits and withdrawals may be used. In another alternative, an interactive voice response system may be used to interact with and carry out transactions on the system.

Still further, a variety of devices may couple to the service architecture via Bluetooth™, Radio Frequency Identification (RFID) and/or Near Field Communication (NFC).

In still another alternative, user devices may include have an electronic wallet program running or work as e-wallets. Such devices may be configured to initiate and carry out transactions with, or communicate them to the system independently and autonomously.

In a still further alternative, user devices may be configured to record details of a transaction while disconnected from the system and when connected forward those details to the system to finalize the transaction and/or synchronize with the system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method for completing a financial transaction between a first account holder and a second account holder via an insecure communication network; comprising:
receiving a plurality of transaction requests from at least a first transaction interface and a second transaction interface via the insecure network, each transaction interface receiving user input including transaction instructions and outputting the instructions in a transaction request via the insecure network in a common syntax, at least one of the plurality of transaction requests transmitted in an un-encoded format, the common syntax including at least a first transaction command, transaction parameters, a user token and an authentication token;
parsing the transaction command, transaction parameters, user token and authentication token;
authenticating each transaction request using the user token and the authentication token;
evaluating each transaction request against a set of permissible transaction rules; and
if the transaction request is permitted, executing the transaction.

2. The method of claim 1, wherein said first transaction interface is a SMS text message.

3. The system of claim 1 wherein the method further includes:
Receiving a portion of a transaction request via an SMS text message;
Forwarding a reply in an SMS text message requesting at least said user token;
Receiving a second portion of the transaction request via a second SMS text message including at least said user token.

4. The method of claim 2 wherein the second transaction interface is a browser web page (browser) from a plurality of user devices that are capable of connecting to a communication network.

5. The method of claim 2 wherein the second transaction interface is a software application installed in a plurality of user devices that are capable of connecting to a communication network.

6. The method of claim 2 wherein the second transaction interface is an automated teller apparatus coupled to the secure network.

7. The method of claim 1, wherein the step of evaluating includes checking rules which prevent transactions if not sufficient funds are available to sustain the transaction.

8. The method of claim 7, wherein said rules restrict transactions of more than an accumulated and predetermined value in a given period of time.

9. The method of claim 7, wherein said rules restrict deposits if a predetermined account balance is exceeded.

10. A method of providing a fund transfer between a first user and a second user, comprising
receiving a plurality of requests to create a stored value account, at least one of said plurality of requests being received from a first transaction interface via an insecure network, at least a second of said plurality of requests being received from a second, different transaction interface via a secure network, each transaction interface receiving user input including transaction instructions and outputting the instructions in a transaction request via the networks in a common syntax, at least one of the plurality of transaction requests transmitted in an un-encoded format, the common syntax including at least a first transaction command, transaction parameters, a user token, an authentication token, and a pre-paid transaction authentication number;
parsing the transaction command, transaction parameters, user token and user authentication; and
creating a stored value account for said user with said user token
authenticating each transaction request using the user token and authentication token;

11. The method of claim 10 wherein the user authentication token includes at least a mobile phone number.

12. The method of claim 10 wherein said stored value account can be held in a plurality of currencies.

13. The method of claim 10 wherein said transaction authentication number is provided by physical prepaid-cards to add funds to a stored value account.

14. The method of claim 10 wherein said transaction authentication number is provided by a virtual prepaid-cards to add funds to a stored value account.

15. The method of claim 10 wherein each of said transaction requests includes a set of information identifying the user, and wherein the method further includes receiving a request to search one or more fields in the set of information, and returning a set of search results matching user records in the field of information.

16. The method of claim 15 wherein the request to search is received from an SMS text message.

17. The method of claim 15 wherein the request to search is received from an Web form interface.

18 A computer readable medium including code for instructing a processing apparatus to perform the steps of:
receiving a plurality of transaction requests from at least a first transaction interface and a second transaction interface via the insecure network, each transaction interface receiving user input including transaction instructions and outputting the instructions in a transaction request via the insecure network in a common syntax, at least one of the plurality of transaction requests transmitted in an un-encoded format, the common syntax including at least a first transaction command, transaction parameters, a user token and an authentication token;
parsing the transaction command, transaction parameters, user token and authentication token;
authenticating each transaction request using the user token and the authentication token;
evaluating each transaction request against a set of permissible transaction rules; and
if the transaction request is permitted, executing the transaction
